(19) United States
(12) Patent Application Publication
(10) Pub. No.: US 2026/0023920 A1
(43) Pub. Date: Jan. 22, 2026

(54) Multi-Channel Intent-Specific Communication Session Summarization

(71) Applicant: OPTUM, INC., Minnetonka, MN (US)

(72) Inventors: Siddhant Srivastava, Uttar Pradesh (IN); Ankur Gulati, Haryana (IN); Tanmey Rawal, Haryana (IN); Aditya Teja Josyula, Collierville, TN (US); Raman Nayal, Fair Lawn, NJ (US); Maher Ardat, Victoria, MN (US)

(21) Appl. No.: 19/005,937

(22) Filed: Dec. 30, 2024

Related U.S. Application Data
(60) Provisional application No. 63/673,472, filed on Jul. 19, 2024.

(51) Int. Cl. G06F 40/166; G06F 40/35; G06F 40/40; H04M 3/42; H04M 3/51

(52) U.S. Cl. CPC G06F 40/166; G06F 40/35; G06F 40/40; H04M 3/42221; H04M 3/5175; H04M 2201/38; H04M 2201/40

(57) ABSTRACT

Techniques for summarizing conversations in real-time are disclosed. The techniques include generating a transcript of the communication session and, during the communication session, obtaining a user-selected intent from a user. Based on the user-selected intent and at least a portion of the transcript, a prompt for a large language model (LLM) is generated. The prompt is then inputted into an LLM to provide a summary of the communication session that aligns with the selected intent. The summary can then be displayed to the user, e.g., for review and/or editing. The process may repeat for multiple user-selected intents, for example. These techniques can enhance the accuracy and/or efficiency of communication session summarization, including summarization of complex, multi-intent conversations.

### CROSS-REFERENCE TO RELATED APPLICATIONS

This application claims the benefit of U.S. Provisional Patent Application No. 63/673,472, filed on Jul. 19, 2024, the entire disclosure of which is hereby incorporated herein by reference for any purposes. This application also issncorporates by reference for any purposes the entire disclosure of U.S. Patent Application No. [Unassigned], titled “Multi-Channel Intent Summarization Using Utterance Shift and Span Detection”, filed Dec. 30, 2024.

### TECHNICAL FIELD

The present disclosure generally relates to communication session summarization techniques, and more particularly, to techniques for summarizing multi-intent conversations based on a user trigger.

### BACKGROUND

Contact centers handle a large volume of communication sessions daily, and it is essential to document each interaction for quality assurance, compliance, and training purposes. Traditionally, advocates have been responsible for manually summarizing communication sessions, which is a time-consuming, inefficient, error-prone, and often inaccurate process. Recent advancements in natural language processing (NLP) and machine learning (ML) have led to the development of communication session summarization systems. However, these systems often fall short in terms of accuracy (e.g., hallucinations), latency, and resilience (e.g., ability to handle multi-intent communication sessions).

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example computing system in which various embodiments of the present disclosure may be implemented.

FIG. 2A depicts an example textual transcript with documentation and intent-level summarization, in accordance with various embodiments described herein.

FIG. 2B depicts an example textual transcript with advocate comments, in accordance with various embodiments described herein.

FIG. 3 depicts an example customer relationship management (CRM) dashboard with a plurality of intents, in accordance with various embodiments described herein.

FIG. 4 depicts a flow diagram representing an example computer-implemented method, in accordance with various embodiments described herein.

### DETAILED DESCRIPTION

As noted in the Background section, existing communication session summarization techniques for multi-intent conversations can be associated with numerous problems (e.g., poor accuracy, latency, and/or resiliency). Broadly speaking, the techniques of the present disclosure relate to techniques (e.g., hardware, software, large language model(s), or a combination thereof; process(es)) for communication session summarization of multi-intent conversations with low latency, in an accurate and resilient manner.

Generally, the disclosed techniques can summarize a textual transcript, or a portion thereof, by customizing a prompt for a large language model (LLM) based on an intent selected by a user (e.g., call handler or advocate). For example, while handling a communication session, a user may select the intent “review medical benefits” from a drop-down menu of different, predetermined intents. The disclosed techniques may then use at least part of the textual transcript (e.g., the entire transcript up to that point in time, or the portion of the transcript since the user selected a previous intent, etc.) and the user-selected first intent to generate the prompt. The prompt can also include additional language that causes/directs the LLM to output a summary of the communication session (or communication session portion) in the context of the user-selected intent.

As discussed, existing communication session summarization techniques can fall short in terms of accuracy, latency, and resilience. The techniques of the present disclosure have technical advantages over such techniques. By constraining communication session summarization with a user-selected intent, the disclosed techniques maintain various advantages of automated communication session summarization (e.g., greater speed, consistency, etc.) while reducing the risk of hallucinations (e.g., misidentifying the participant's intent), even for complex, multi-intent conversations. Moreover, by leveraging user guidance during the communication session with respect to the timing of different intents being discussed, the disclosed techniques can result in intent-specific summarizations that are provided with less delay/latency (e.g., without having to wait for completion of the communication session in order to reliably identify the points at which certain participant intents are no longer being discussed).

Thus, the disclosed techniques can improve the functioning of a computing system by avoiding adverse effects such as inaccuracies/hallucinations, latency, and lack of resiliency. Further still, the disclosed techniques are highly scalable in that the techniques can incorporate participant metadata (e.g., name, address, date of birth, policy number, plan type, etc.) when generating a summary. In some embodiments, the disclosed techniques may incorporate participant metadata when generating a communication session summarization prompt. The participant metadata may be selected by a user (e.g., an advocate) and/or may be pre-populated by a large language model extracting the relevant participant metadata from a larger set of participant metadata based on the selected intent and at least part of the textual transcript (e.g., for a selected intent of “review benefits” the large language model may extract the participant's plan number from the larger set of participant metadata and pre-populate the plan number when generating the communication session summarization prompt).

The disclosed techniques include specific features other than what is well-understood, routine, conventional activity in the field, and add unconventional steps that demonstrate, in various embodiments, particular useful applications, such as, for example, receiving, during a communication session, a user selection of an intent, and generating a prompt for an LLM based at least in part on the selected intent and at least a portion of the textual transcript.

Of course, it should be appreciated that the advantages and technical improvements described above and elsewhere herein are not the only advantages and/or technical improvements that may be realized because of the techniques described herein. Other advantages and/or technical improvements to the functioning of a computer itself or other technologies or technical fields may be apparent to one of ordinary skill in the art. Moreover, it will be appreciated that the disclosed techniques, while primarily described herein in the context of healthcare (e.g., health insurance), may instead apply to other types of industries, organizations, enterprises, etc.

### Example Computing System

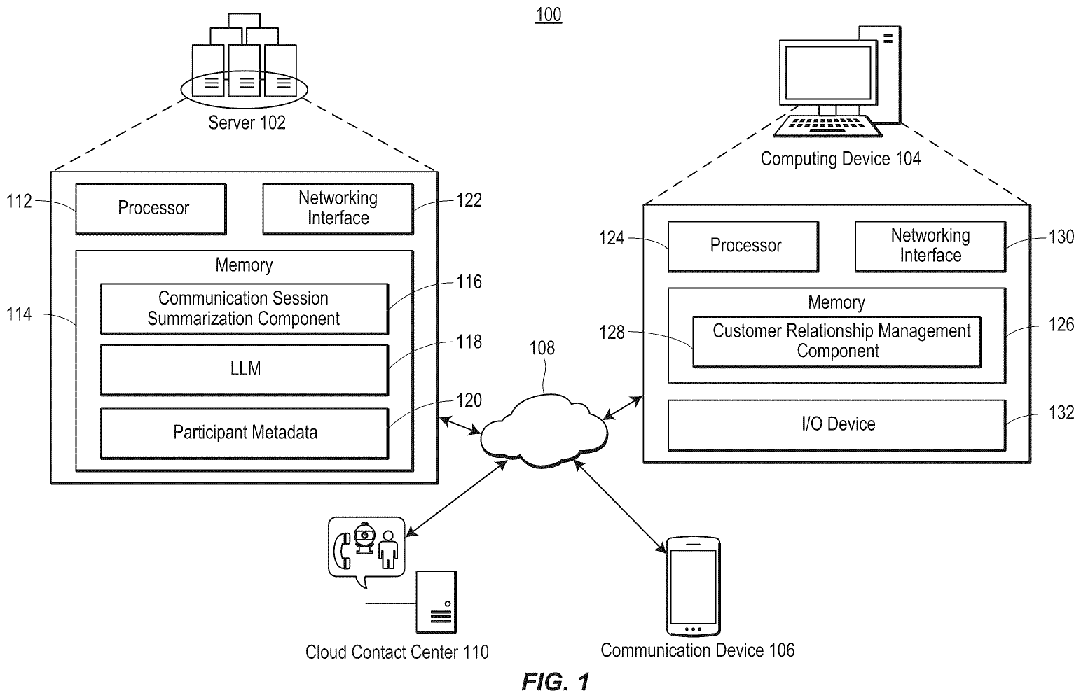

FIG. 1 depicts an example computing environment 100 in which various techniques and/or embodiments of the present disclosure can be implemented. The example computing environment 100 includes a server 102, a computing device 104, a communication device 106, and a cloud contact center 110. It should be appreciated that, while the server 102, computing device 104, communication device 106, and cloud contact center 110 are illustrated in FIG. 1 as single components, the example computing environment 100 may include multiple (e.g., dozens, hundreds, thousands) of servers 102, computing devices 104, communication devices 106, and/or cloud contact centers 110. In some embodiments the server 102, computing device 104, and cloud contact center 110 may be part of the same computing device and/or system.

The server 102 may be associated with an organization that operates, maintains, oversees, and/or services a call center, customer service center, contact center, support center, etc. and is generally configured to analyze and summarize communication sessions between individuals (e.g., customers) and the organizations representatives (e.g., advocates). The computing device 104 may be associated with the same organization as server 102 and is generally configured to facilitate interactions between representatives associated with the organization and individuals. The computing device 104 includes a processor 124, a memory 126, a networking interface 130, and an I/O device 132. The communication device 106 may be associated with an individual seeking to contact the organization associated with server 102 and/or computing device 104. The network 108 is generally configured to facilitate communication among and/or between the components of the example computing environment 100 and/or other components (e.g., via the Internet). The cloud contact center 110 is generally configured to provide an organization (e.g., the organization associated with server 102 and/or computing device 104) with contact center solutions.

In some examples, the example computing environment 100 summarizes communication sessions by a server 102 accessing the communication session summarization component 116 (e.g., using an application programming interface (API)), and using user-selected intent(s) (e.g., topics, themes, matters, issues, subjects, etc.) and at least a portion of the textual transcript to generate a first prompt. Generating a summary of the communication session directed to the user-selected intent may include, for example, prompting an LLM 118 with the first prompt. In some embodiments, generating a prompt may include using the entire textual transcript and the intent(s) discussed on the communication session. Generating a summary of the entire communication session may include, for example, prompting an LLM 118 with the prompt.

In the example of FIG. 1, the server 102 performs at least some of the functionalities and techniques disclosed herein, such as summarizing a communication session. The server 102 may include only one server, or multiple servers that are co-located and/or remotely distributed. The server 102 may be part of a cloud network or may otherwise communicate with other hardware or software components within one or more cloud computing environments to send, retrieve, or otherwise analyze data and/or information described herein. In some example embodiments, the computing environment 100 comprises an on-premises computing environment, a multi-cloud computing environment, a public cloud computing environment, a private cloud computing environment, and/or a hybrid cloud computing environment. The server 102 includes a processor 112, a memory 114, and/or a networking interface 122. It should be appreciated that, while the server 102 is illustrated in FIG. 1 as a single component, the server 102 may include multiple (e.g., dozens, hundreds, thousands, etc.) of computing devices (e.g., servers) and/or other components.

The processor 112 includes any suitable number of processors and/or processor types. In some examples, the processor 112 includes one or more central processing units (CPUs), one or more graphics processing units (GPUs), one or more tensor processing units (TPUs), one or more field-programmable gate arrays (FPGAs), one or more application-specific integrated circuits (ASICs), and/or the like. Generally, the processor 112 comprises hardware configured to execute instructions (i.e., processor-executable code/instructions) stored in the memory 114.

The networking interface 122 comprises one or more hardware components that generally enable the server 102 to communicate via one or more network(s) (e.g., network 108) with other components and/or devices of the computing environment 100, such as the computing device 104, the communication device 106, the server 102 itself (e.g., between components of a server, between two or more servers within the server 102, etc.), and/or other suitable systems/devices or combinations thereof. More specifically, the networking interface 122 enables the server 102 to communicate with any component of the example computing environment 100 across the network 108. The networking interface 122 may comprise hardware and/or software that operates according to at least one communication protocol of the network 108.

The memory 114 includes any suitable memory type(s), including one or more volatile memories (e.g., dynamic and/or static random-access memory (RAM)) and/or non-volatile memories (e.g., read-only memory (ROM), erasable programmable ROM (EPROM), electrically EROM (EEROM), NAND flash, and/or solid state drive(s) (SSD(s))), all or any of which are examples of non-transitory computer-readable media. In some examples, the memory 114 stores one or more of: an operating system; one or more software components (e.g., firmware, application(s), binary, source code, executable instructions, large language model(s)); transient data and/or code loaded and/or operated on by one or more software component(s); and/or other suitable components/data. In some examples, the memory 114 stores the communication session summarization component 116, LLM 118, and/or participant metadata 120, which are discussed further below. The memory 114 may additionally store other data, such as one or more other applications, databases, etc.

The communication session summarization component 116, when executed by the processor 112, generally performs one or more communication session summarization functions, such as receiving (or possibly generating) textual transcripts based on communication sessions from participants (e.g., a member utilizing communication device 106), receiving user selections of participant intents, generating prompts based on the selected intents and the textual transcripts, and using an LLM and the prompts to generate summaries of the communication sessions, where the summaries reflect/correspond to the user-selected intents. In some embodiments the communication session summarization component 116 is generally configured to access or otherwise use LLM 118 to summarize textual transcripts (or portions thereof) on an intent-by-intent basis.

The LLM 118 may be a transformer-based model trained to use text as input and generate output text or, in other embodiments, may be a multimodal LLM that operates upon and/or generates text along with one or more other types of content (e.g., images, video frames, and/or audio). The LLM 118 may comprise machine-learned model component(s), such as neural network(s), decision tree(s), and/or the like. The LLM 118 may receive a text prompt (referred to herein at times as simply a “prompt”) as an input, process the text prompt, and output text content responsive to the text prompt. The LLM 118 may perform various natural language processing tasks as needed to understand a text query/prompt and generate a response to the text query/prompt. In some embodiments, the LLM 118 performs one or more pre-processing operations and/or post-processing operations. For example, in a pre-processing operation a transformer-based or other LLM 118 may augment the original prompt to add sufficient context (e.g., context based on processing inputs determined from participant data, a variety of intents, and/or the like) associated with the prompt. In a post-processing operation, the transformer-based LLM 118 may review and alter (e.g., self-refinement), as necessary, an output of the same and/or a different transformer-based machine-learned model.

In some embodiments with a transformer-based model architecture, the transformer-based LLM 118 may comprise an encoder that tokenizes the input and determines embeddings for the tokens, and a decoder that generates the output based at least in part on the embeddings. The transformer-based LLM 118 may incorporate self-attention, cross-attention, and/or any suitable self-attention or attention mechanisms to facilitate more accurate output. In some embodiments, such a transformer-based LLM 118 may include different configurations of self- and/or cross-attention, followed by one or more neural networks (e.g., feedforward layer(s)), recurrent layer(s), aggregation layer(s) (e.g., using SoftMax, matrix multiplication, and/or other aggregation techniques), and/or the like. The transformer-based LLM 118 may be a general-purpose model (e.g., trained on a wide array of publicly available datasets such as web pages, documents, etc., available via the Internet), such as generative pre-trained transformer (GPT) 3.5, bi-directional encoder representations from transformers (BERT), or a domain-specific model (e.g., trained and/or fine-tuned on custom and/or proprietary datasets), for example. Such a general purpose LLM 118 may be further trained and/or finetuned using participant metadata, intents, and textual transcripts to generate summaries.

In another embodiment, the LLM 118 may be and/or include machine-learned models to summarize communication sessions, detect sentiment, etc. such as TextRank, Latent Semantic Analysis (LSA), Hidden Markov Models (HMM), Support Vector Machines (SVM), clustering, recurrent neural networks (RNN), Convolutional neural networks (CNN), naïve bayes, etc.

It should be understood that the LLM 118 may be locally stored in the server 102 using memory 114 and/or may be cloud based (e.g., hosted by OpenAIR®), and accessed via an API or the like. It should be appreciated that some embodiments may include combinations of the foregoing such as using a locally hosted LLM 118 in some scenarios and a different cloud based LLM for other scenarios (i.e., for privacy reasons, computational efficiency, to optimize costs, etc.).

The participant metadata 120 may include data and/or information associated with the participant (e.g., a member, customer, patron, subscriber, client, guest, etc.) that an organization would ordinarily store and/or collect (e.g., name, address, date of birth, policy number, plan type, coverage details, claims history, payment history, provider network, customer service interactions, etc.). In certain embodiments, the data and/or information associated with the participant is or includes a set of such text strings, files, documents, and/or any other suitable data/datatype(s) or combinations thereof. While depicted in FIG. 1 as being stored within the memory 114 of the server 102, the participant metadata 120 may instead also be stored elsewhere in the example computing environment 100 and/or at any other suitable location using any suitable techniques (e.g., at on-premises servers, cloud storage services, customer relationship management systems, data warehouses, enterprise resource planning systems, etc.).

The communication session summarization component 116 and/or the customer relationship management component 128 may use the participant metadata 120 (e.g., in a prompt for the LLM 118) to improve the accuracy of summaries. In some embodiments a user (e.g., an advocate) may select a portion of the participant metadata 120 (e.g., a participant's name, phone number, policy number, etc.) from a larger set of participant metadata (e.g., all the metadata associated with a participant, all participant metadata related to a presently selected intent, all participant metadata related to a previously selected intent, etc.) via the customer relationship management component 128. The communication session summarization component 116 may use the select the participant metadata to generate a prompt for the LLM 118. In other embodiments the LLM 118 itself, or a different LLM, may extract the relevant participant metadata from the larger set of participant metadata. The LLM 118 may extract the relevant participant metadata based on at least part of the textual transcript and/or a user-selected intent. For example, for a selected intent of “send informative email”, the LLM 118 may extract the participant's email address from the larger set of participant metadata, and the communication session summarization component 116 may pre-populate the participant's email address when generating the prompt for the LLM 118 to summarize the communication session.

In some embodiments, the computing device 104 includes a computer (e.g., desktop computer, laptop computer, terminal), a mobile device, a wearable, augmented reality glasses/headsets, virtual reality glasses/headsets, mixed or extended reality glasses/headsets, and/or other suitable computing device(s). The computing device 104 includes a processor 124 (e.g., similar to the processor 112) and a memory 126 (e.g., similar to the memory 114) for storing and executing one or more software components, computer-executable instructions, etc. The computing device 104 may further include a networking interface 130 (e.g., which may be the same as or similar to the networking interface 122) and an I/O device 132 (e.g., a display, such as a monitor; a user input device, such as a keyboard, mouse, trackpad, gesture and/or biometric tracking device, or the like). The computing device 104 may access services, devices, and/or components of the computing environment 100 via the network 108. In some embodiments, the computing device 104 transmits and/or receives (e.g., to and/or from the server 102 and/or the cloud contact center 110) data and/or information associated with the communication session summarization techniques described herein (e.g., one or more intents, at least a portion of the textual transcript, an entire textual transcript, one or more intent-specific summaries, one or more entire communication session summaries, participant metadata, a portion of the participant metadata, etc.). It should be appreciated that, while computing device 104 is illustrated in FIG. 1 as a single component, the computing device 104 may include multiple (e.g., dozens, hundreds, thousands) components/devices.

The customer relationship management component 128 generally manages interactions between users and participants. The customer relationship management component 128 may provide a centralized platform with a user interface (UI) enabling a user (e.g., an advocate) to provide personalized and efficient service. The customer relationship management component 128 may be an application developed and/or managed by a third-party CRM software provider (e.g., Salesforce®, HubSpot®, Microsoft Dynamics 365®, Zoho CRM, Pipedrive®, etc.). The customer relationship management component 128, when executed by the processor 124, generally performs one or more communication session summarization functions, such as receiving, during communication sessions, user selections of intents, receiving user selections of participant metadata, receiving user selections of a user trigger, receiving communication session summaries for display to users, receiving user revisions of communication session summaries, etc.

The customer relationship management component 128 may receive user selections of intents, portions of participant metadata 120, and/or users triggers to generate prompts for accurate summaries. For example, by integrating the participant metadata 120 into the summarization techniques described herein, the LLM 118 may ensure that existing information from the textual transcript is accurate (i.e., matches the participant metadata 120). By utilizing the participant metadata 120 the present techniques allow for the LLM 118 to use trusted/authoritative data and/or information to remedy any discrepancies that may arise from mistranscriptions (e.g., part of the members policy number may transcribe as “14” instead of “40” and the LLM 118 uses the authoritative members policy number from the participant metadata 120 when generating a summary), and/or to further reduce the likelihood that the LLM 118 will hallucinate or otherwise provide inaccurate summaries (e.g., output a summary reflecting an intent that cannot possibly be the intent of a participant associated with a particular gender, location, etc.). The customer relationship management component 128 may utilize communication session identifiers and intent identifiers to avoid ambiguity where there may be a one-to-one (e.g., one communication session with one intent discussed), one-to many (e.g., a multi-intent conversation with one communication session and many intents), and/or many-to-many relationship (e.g., multiple multi-intent communication sessions with multiple communication sessions and multiple intents).

The communication device 106 generally facilitates communication between individuals (e.g., customers) and an organization (e.g., one that operates, maintains, oversees, and/or services a call center, customer service center, contact center, support center, etc.). The communication device 106 may be a smartphone, a tablet, a laptop, a desktop computer, a smart speaker, a smart watch, etc. of customer or potential customer, for example. It should be appreciated that, while communication device 106, is illustrated in FIG. 1 as a single component, the communication device 106 may include multiple (e.g., dozens, hundreds, thousands) component/devices. In some embodiments, for example, the communication device 106 includes one or more of the foregoing components/devices in combination, such as smartphone tablet combination (e.g., a phablet) or a tablet laptop combination (e.g., a 2-in-1 tablet laptop), etc.

The network 108 includes wired and/or wireless communication network(s) such as a cellular network (e.g., 5G®, 4G LTE®, 3G®), a Wi-Fi® network (802.11 standards), a microwave access network (e.g., WiMAX®), and/or any other suitable wide area network (WAN), local area network (LAN), personal area network (PAN), etc. Moreover, the network 108 may be a single communication network, or may include multiple communication networks of one or more types (e.g., one or more wired and/or PANs or LANs, and/or one or more WANs such as the Internet). In some embodiments, the network 108 includes multiple, entirely distinct networks (e.g., one or more networks for communications between server 102 and computing device 104, and a separate, Bluetooth® or wireless LAN (WLAN) network for communications between server 102 and computing device 104, and so on). It should be appreciated that, while the network 108 is illustrated in FIG. 1 as a single component, the network 108 may include multiple (e.g., dozens, hundreds, thousands) networks 108.

The cloud contact center 110 generally provides an enterprise with contact center solutions. The cloud contact center 110 may be a cloud-based, omnichannel contact center solution (e.g., an omni Genesys® call platform, Five9®, Amazon Connect®, Avaya® OneCloud CCaas, Talkdesk®, NICE inContact CXone®, Twilio Flex®, etc.). The cloud contact center 110 (e.g., omni Genesys® call platform) may integrate a voice analytics platform (VAP) and an event hub to enable real-time, granular (e.g., utterance level, sentence level, word level, phoneme level, etc.) transcription of communication sessions by means of suitable automated speech recognition (ASR) software (e.g., Azure® STT, Google® Cloud Speech-to-Text, Amazon® Transcribe, IBM Watson® Speech to Text, Deepgram®, AssemblyAI, Rev.ai, etc.). It should be appreciated that, while the cloud contact center 110, is illustrated in FIG. 1 as a single component, the cloud contact center 110 may include multiple (e.g., dozens, hundreds, thousands) components/devices. In some embodiments, the computing environment 100 excludes the cloud contact center 110 (e.g., if the server 102 or computing device 104 performs textual transcription).

### Example Intent-Specific Communication Session Summarization Flows

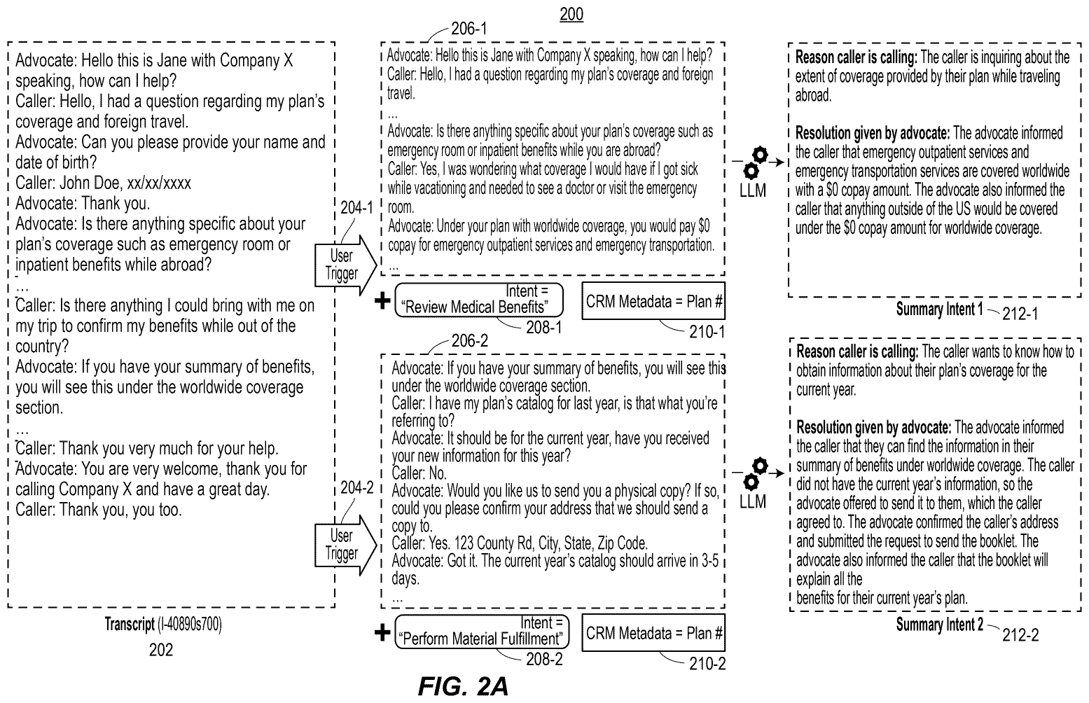

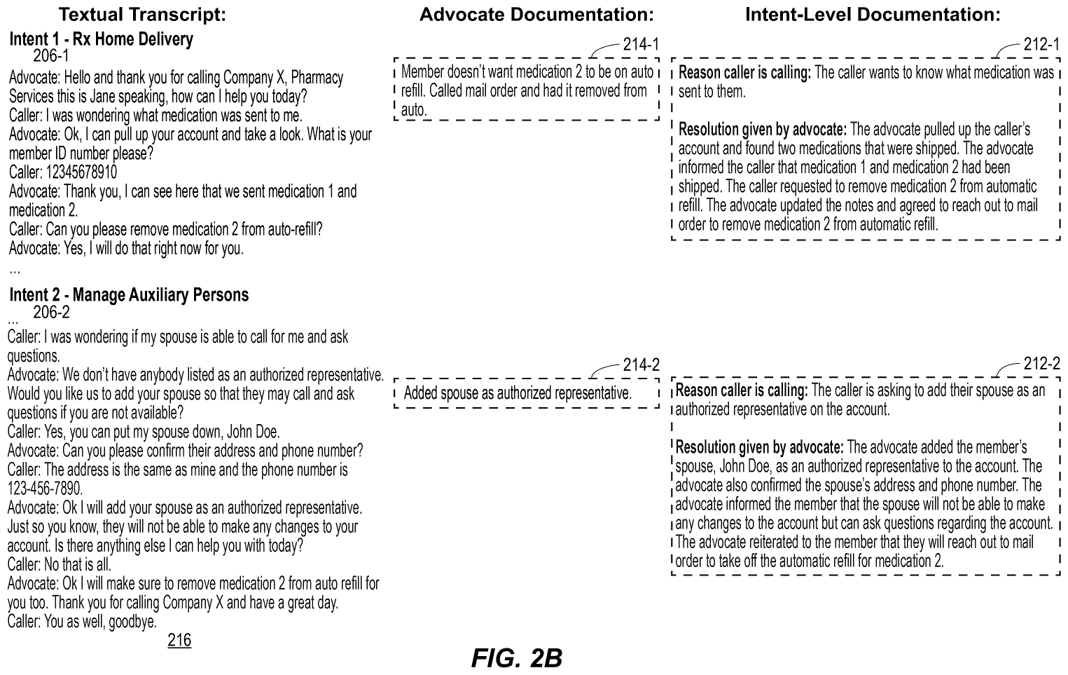

FIG. 2A depicts an example intent-specific communication session summarization flow 200, in accordance with various embodiments described herein. The summarization flow 200 broadly illustrates the actions performed by components, devices, and/or systems (e.g., the server 102, the communication session summarization component 116, the LLM 118, the computing device 104, and/or the customer relationship management component 128, etc.) of the computing environment 100.

The summarization flow 200 may begin with a participant (e.g., a customer utilizing communication device 106) contacting (e.g., calling, instant messaging, or any other type of real-time communication) an organization (e.g., via the cloud contact center 110). The participant may receive assistance from an advocate utilizing the customer relationship management component 128. The “Caller” of FIGS. 2A and 2B may be, for example, a participant (e.g., member, patron, client, user, buyer, consumer, devotee, follower, supporter, visitor, etc.) of an organization seeking to contact an organization by any suitable means (e.g., phone call, video call, online chat/messaging platforms, voice over Internet protocol (VoIP) services, applications specifically designed for customer service, etc.). The “Advocate” of FIGS. 2A and 2B may be, for example, any suitable user (e.g., customer service agent, support specialist, help desk agent, account manager, customer experience associate, relationship manager, call center ambassador, client care coordinator, technical support representative, service helpline agent, etc.) associated with an organization (e.g., a health insurance company).

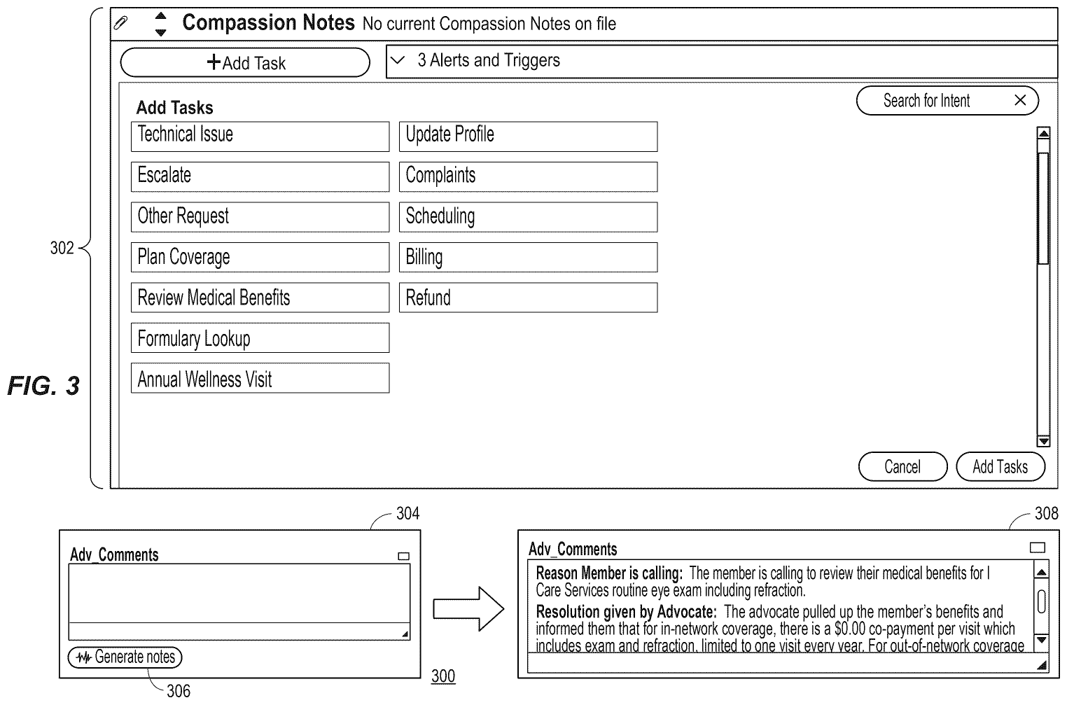

During the communication session, the cloud contact center 110 may generate a textual transcript 202. The textual transcript 202 may be a transcript of utterances during the conversation between the advocate and participant (e.g., to resolve one or more problems and/or questions). In some embodiments, cloud contact center 110 generates the textual transcript 202 in real-time as the communication session occurs, such that the textual transcript 202 builds/expands throughout the communication session. After resolving an intent (e.g., after the advocate and participant having addressed, within the communication session, that particular intent of the participant, regardless of whether any issues/problems associated with the intent were completely resolved), the advocate may select a corresponding intent (e.g., in FIG. 2A, “Review Medical Benefits”) from a set of pre-determined intents (e.g., a set of intents similar to intents 302, discussed below in connection with the example of FIG. 3). The advocate using the customer relationship management component 128 may also select one or more user interface controls/inputs (e.g., a “Summarize” or “Submit” virtual button), with the selection serving as user trigger 204-1. The customer relationship management component 128 may send the selected intent 208-1 to the communication session summarization component 116, which may also receive from the cloud contact center 110 a transcript portion 206-1. In embodiments where the cloud contact center 110 generates the textual transcript 202 in real-time, the transcript portion 206-1 may be identical to the textual transcript 202 (i.e., as the textual transcript 202 exists at the time of the user trigger 204-1). The communication session summarization component 116 may generate (e.g., format, package, etc.) a prompt for a summary 212-1 using the transcript portion 206-1 and selected intent 208-1. The communication session summarization component 116 may then input the generated prompt into the LLM 118 to generate/output a summary 212-1. The summary 212-1 may generally be an overview of the conversation for the transcript portion 206-1 corresponding to the selected intent 208-1. The communication session summarization component 116 may then send the summary 212-1 corresponding to the transcript portion 206-1 and selected intent 208-1 to the customer relationship management component 128 for the advocate to review and save (e.g., to a database for storing customer interactions).

The summarization flow 200 may further include the advocate resolving one or more additional intents of the participant during a multi-intent conversation. After resolving a further intent, the advocate may select the corresponding intent (e.g., in FIG. 2A, “Perform Material Fulfilment”) from the set of pre-determined intents. The advocate may also select one or more user interface controls/inputs (e.g., a “Summarize” or “Submit” virtual button), with the selection serving as user trigger 204-2. For ease of explanation, the following description of FIGS. 2A and 2B refers to embodiments in which the textual transcript 202 is generated by cloud contact center 110 (e.g., in real-time as the conversation occurs). In some embodiments, cloud contact center 110 begins generating the textual transcript 202 (e.g., after the communication session is complete). In other embodiments, however, the transcript may be generated by server 102 or another suitable device or system. In some embodiments, communication session summarization component 116 may generate the transcript portion 206-2 by extracting the portion 206-2 from the textual transcript 202. The communication session summarization component 116 may receive from the cloud contact center 110 the transcript portion 206-2, which may be a subset of the textual transcript 202 between a first time (e.g., corresponding to user trigger 204-1) and a second time corresponding to the user trigger 204-2.

The advocate's selection of one or more user interface controls/inputs serving as user trigger 204-1, 204-2, etc. may cause the customer relationship management component 128 or another component to generate a corresponding timestamp. The customer relationship management component 128 may then send the corresponding timestamp to the cloud contact center 110 to ensure that relevant transcript portions are sent to the communication session summarization component 116. For example, in some embodiments where the transcript 202 is generated in real time the timestamp corresponding to user trigger 204-1 represents the beginning of transcript portion 206-2, and the cloud contact center 110 determines the end of transcript portion 206-2 based on the current end of generated transcript 202 (e.g., the end of the textual transcript 202 as it exists at the time of the user trigger 204-2). In some other embodiments where the textual transcript is generated after the communication session, the cloud contact center 110 may use the timestamp corresponding to user trigger 204-1 to indicate the beginning of transcript portion 206-2 and the timestamp corresponding to user trigger 204-2 to indicate the end of transcript portion 206-2.

The communication session summarization component 116 may generate a prompt for a summary 212-2 using the transcript portion 206-2 and selected intent 208-2. The communication session summarization component 116 may then input the generated prompt into LLM 118 to generate/output the summary 212-2. The communication session summarization component 116 may then send the summary 212-2 corresponding to the transcript portion 206-2 and selected intent 208-2 to the customer relationship management component 128 for the advocate to review and save. In some embodiments and/or scenarios, the summarization flow 200 may continue as described above for the second intent for any suitable number of additional intents.

For each of one, some, or all resolved intents, the advocate may select an intent from the pre-determined set of intents when (e.g., shortly after) a particular intent (e.g., question and/or problem) discussed on the communication session is resolved (e.g., solved, answered, etc.). In other embodiments and/or scenarios, however, the advocate may instead select the intent at an earlier time (e.g., as soon as the participant's intent becomes clear to the advocate, before resolution of the intent). In some embodiments where the advocate's selection of an intent from the set of pre-determined intents occurs after resolution of the intent in the communication session, the selection of the intent may itself serve as the user trigger (e.g., user trigger 204-1 or 204-2).

In some embodiments, the summarization flow 200 may incorporate CRM metadata (i.e., additional data and/or information) into the summarization process. When the advocate selects an intent from the set of predetermined intents, in these embodiments, the advocate can also select this additional data and/or information about the participant (e.g., in the example of FIG. 2A, the caller's Medicare advantage plan number) for use in preparing one or more intent summaries. In some embodiments the advocate selects a portion of participant metadata 120 (e.g., the advocate may select a portion of all available metadata associated with the participant). In other embodiments the advocate selects from a subset of participant metadata 120 (e.g., only the metadata associated with the participant that is relevant to the selected intent, and/or a previously selected intent, etc.).

In the case of the first intent, the customer relationship management component 128 may send the selected additional data and/or information to the communication session summarization component 116 as CRM metadata 210-1, which may be packaged into a suitable filetype, for example. In these embodiments, the communication session summarization component 116 may generate the LLM prompt discussed above for a summary 212-1 using not only the transcript portion 206-1 and selected intent 208-1, but also the CRM metadata 210-1. The use of CRM metadata 210-1 advantageously enriches the prompt with authoritative data to help ensure summaries are accurate, including circumventing issues that may arise due to mistranscription and/or LLM hallucination.

The summarization flow 200 may include additionally resolved intents with additional CRM metadata 210-2. The advocate may select additional data and/or information about a participant (e.g., Medicare advantage plan number) to provide additional context to the summary 212-2. The CRM metadata 210-1 and CRM metadata 210-2 may be the same (e.g., both Medicare advantage plan #) or may differ (e.g., based on the chosen intent 208-1 and chosen intent 208-2 being different). In some embodiments and/or scenarios, the summarization flow 200 may continue as described above for CRM-metadata 210-2 for any suitable number of additional intents and CRM metadata.

In some non-depicted embodiments LLM 118, when prompted with the chosen intent 208-1, 208-2, etc. may generate the respective CRM metadata 210-1, 210-2, etc. by extracting a relevant portion of participant metadata 120 (e.g., using retrieval augmented generation). In other non-depicted embodiments CRM metadata 210-1, 210-2, etc. may include the corresponding chosen intent 208-1, 208-2, etc., a communication session identifier, and an intent identifier for associating a particular communication session with a particular chosen intent, and/or with advocate comments 214-1, 214-2, etc. discussed in reference to FIG. 2B below.

FIG. 2B depicts an example summarization flow 216. The summarization flow 216 broadly illustrates the actions performed by components, devices, and/or systems (e.g., the server 102, the communication session summarization component 116, the LLM 118, the computing device 104, and/or the customer relationship management component 128, etc.) of the computing environment 100. The summarization flow 216 may generally incorporate advocate comments (e.g., comments 214-1 and 214-2) into the summarization process.

After resolving and/or selecting the first intent, the advocate may use a user interface text input (e.g., virtual text box, microphone with a speech-to-text tool, etc.) to provide additional context (e.g., in the example of FIG. 2B, the member doesn't want to be on auto refill and member has been removed from auto refill) that the advocate thinks may not be readily enough apparent from the textual transcript 202, transcript portion 206-1, selected intent 208-1, and/or CRM metadata 210-1. As before, the advocate may select one or more user interface controls/inputs serving as a user trigger 204-1. The customer relationship management component 128 may send an associated user trigger timestamp to the cloud contact center 110. The customer relationship management component 128 may send the selected intent 208-1 and advocate comments 214-1 to the communication session summarization component 116. The communication session summarization component 116 may receive from the cloud contact center 110 the transcript portion 206-1 representing the textual transcript 202 between a first time (e.g., beginning of the communication session) and a second time corresponding to the user trigger 204-1. The communication session summarization component 116 may generate a prompt for a summary 212-1 using the transcript portion 206-1, selected intent 208-1, and advocate comments 214-1. The communication session summarization component 116 may input the generated prompt into the LLM 118 to generate/output the summary 212-1. The use of advocate comments 214-1 advantageously enriches the prompt with data representing an additional, human perspective, to help ensure summaries are accurate, including circumventing issues that may arise due to mistranscription and/or LLM hallucination. The communication session summarization component 116 may then send the summary 212-1 corresponding to the transcript portion 206-1, selected intent 208-1, and advocate comments 214-1 to the customer relationship management component 128 for the advocate to review and save.

The summarization flow 216 may further include the advocate resolving additional intents of the participant with additional advocate comments. After resolving and selecting a further intent, the advocate may add advocate comments 214-2 (e.g., added husband as authorized representative). The advocate comments 214-1 and advocate comments 214-2 may be the same or different (e.g., depending on the selected intent). In some embodiments and/or scenarios, the summarization flow 200 may continue as described above for advocate comments 214-2 for any suitable number of additional intents and advocate comments.

In one embodiment (not depicted) the summarization flow 200 of FIG. 2A or FIG. 2B may also summarize an entire communication session. For example, at the end of the communication session, after resolving all the intents of the participant, the advocate may select a user interface control/input representing a final user trigger indicating the resolution of a final intent. The communication session summarization component 116 may receive from the cloud contact center 110 the textual transcript 202 representing all the utterances of the conversation. The communication session summarization component 116 may generate a prompt for an entire communication session summary using the textual transcript 202 and optionally at least one of the chosen intents 208-1, 208-2, etc., CRM metadata 210-1, 210-2, etc., and/or advocate comments 214-1, 214-2, etc. The communication session summarization component 116 may input the generated prompt into the LLM 118 to generate/output the entire communication session summary. The communication session summarization component 116 may send the entire communication session summary to the customer relationship management component 128 for the advocate to review and save.

In still other embodiments (not depicted), the summarization flow 200 may generate the prompt for LLM 118 using an LLM (LLM 118 or a different LLM), or may use a pre-generated prompt template (e.g., selected from a set of pre-determined prompt templates corresponding to respective intents from the pre-determined set of intents)., when generating summary 212-1 and/or summary 212-2. For example, a LLM generated or pre-generated prompt may include/be prompted by the transcript portion 206-1, 206-2, etc. selected intent 208-1, 208-2, etc. and optionally CRM metadata 210-1, 210-2, etc. and/or advocate comments 214-1, 214-2, etc.

It should be understood that in various embodiments and/or scenarios, there may be any suitable number (e.g., 1, 2, 3, 4, 5, etc.) of intents which may represent one or more iterations, repetitions, cycles, etc. of the summarization flow 200 (or a portion thereof).

### Example Customer Relationship Management Dashboard

FIG. 3 depicts an example customer relationship management dashboard 300. The customer relationship management dashboard 300 illustrates an example UI implemented by components and devices (e.g., the customer relationship management component 128, the computing device 104, etc.) of the computing environment 100. The customer relationship management dashboard 300 may include one or more user interface controls/inputs (e.g., graphical user interface (GUI) icons, virtual buttons, virtual text boxes, etc.) such as a set of pre-determined intents 302, an advocate comments text box 304, a user trigger button 306, and/or an editable summary text box 308. The customer relationship management component 128 may be accessed by a user interacting with the customer relationship management dashboard 300. It should be understood that additional/alternative CRM dashboards and/or UI's may also, or instead, be utilized.

The customer relationship management dashboard 300 may, in some embodiments, facilitate the summarization flow 200 of FIG. 2A. As such, a user (e.g., an advocate) may access the example customer relationship management dashboard 300 during a communication session with a participant (e.g., a member). After the resolution of an intent the user may select the intent from the set of pre-determined intents 302 and select the user trigger button 306 (possibly, but not necessarily, in that particular order). As described above in reference to FIGS. 2A and 2B the customer relationship management component 128 may send a timestamp corresponding to when a user selects the user trigger button 306 and/or selects an intent to the cloud contact center 110 to inform the cloud contact center 110 of the proper bounds (e.g., the end) of the relevant transcript portion 206-1. The communication session summarization component 116 may receive the relevant transcript portion 206-1 from the cloud contact center 110. The communication session summarization component 116 may use the transcript portion 206-1 and the selected intent 208-1 from the set of pre-determined intents 302 to generate a prompt for a summary 212-1. The communication session summarization component 116 may input the generated prompt into the LLM 118 to generate/output the summary 212-1. The communication session summarization component 116 may display the summary 212-1 for the user to review via the editable summary text box 308. The user may edit, amend, modify, etc. the summary 212-1 and save it (e.g., for quality/compliance purposes). A similar process may be used for any additional intents/summaries.

In another embodiment, the customer relationship management dashboard 300 facilitates the summarization flow 216 of FIG. 2B, with the user using the advocate comments text box 304. As before, after the resolution of an intent, the user may select the intent from the set of pre-determined intents 302. The user may add additional context using the advocate comments text box 304, and then select the user trigger button 306. The timestamp corresponding to when the user selects the user trigger button 306 and/or the intent may be sent to the cloud contact center 110 to inform the cloud contact center 110 of the proper bounds of the relevant transcript portion 206-1. The communication session summarization component 116 may generate a prompt for a summary 212-1 using the transcript portion 206-1, the chosen intent 208-1, and the advocate comments 214-1. The communication session summarization component 116 may input the generated prompt into the LLM 118 to generate/output the summary 212-1. The communication session summarization component 116 may display the summary 212-1 to the user to review via the editable summary text box 308. The user may edit, amend, modify, etc. the summary 212-1 and save it (e.g., for quality/compliance purposes). A similar process may be used for any additional intents/summaries.

### Example Computer-Implemented Method

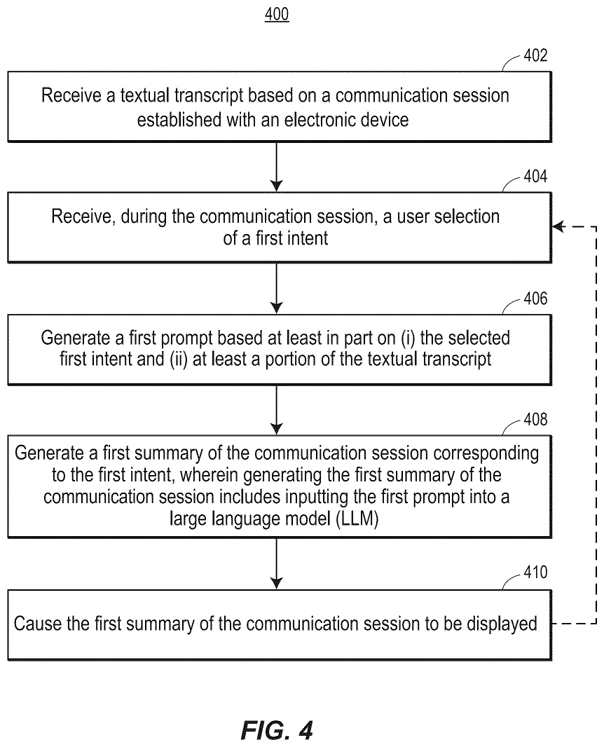

FIG. 4 depicts a flow diagram representing an example computer-implemented method 400. The method 400 may be implemented by one or more processors and/or devices of the example computing environment 100, such as the processors 112 and/or 122, the server 102 (e.g., using communication session summarization component 116), the computing device 104 (e.g., using customer relationship management component 128), the communication device 106, and/or the cloud contact center 110. The blocks shown may be performed in the order shown or, in come embodiments, in a partially different order (or partially in parallel, etc.).

The method 400 includes receiving a textual transcript (e.g., transcript 202) based on a communication session established with an electronic device (block 402). For example, a contact center (e.g., the cloud contact center 110) may integrate a voice analytics platform (VAP) and event hub to enable real-time, granular transcription of communication sessions by capturing the verbal exchange between the participant (e.g., member) and a user (e.g., advocate). The VAP and event hub may convert the spoken utterances into a textual format by means of suitable ASR software (e.g., Azure® STT).

The method 400 also includes receiving, during the communication session, a user selection of a first intent (e.g., intent 208-1) (block 404). For example, the user may select the intent from the set of pre-determined intents 302 using the customer relationship management dashboard 300. The time a user selects an intent from the set of pre-determined intents 302 and/or selects the user trigger button 306 may determine the relevant transcript portion (e.g., portion 206-1) for the cloud contact center 110 to send to the communication session summarization component 116.

The method 400 also includes generating a first prompt based at least in part on (i) the selected first intent and (ii) at least a portion of the textual transcript (block 406). For example, the communication session summarization component 116 may use the selected intent and the transcript portion to generate a prompt. In some embodiments, the prompt may be generated by an LLM (e.g., an LLM other than LLM 118) prompted with the transcript portion and the selected intent. In other embodiments, the prompt may be generated using a pre-generated prompt template, with the selected intent and transcript portion populating fields of the template according to a standardized prompt format/structure.

The method 400 also includes generating a first summary (e.g., summary 212-1) of the communication session corresponding to the selected first intent, wherein generating the first summary includes inputting the first prompt into an LLM (e.g., LLM 118) (block 408). The communication session summarization component 116 may prompt the LLM to generate/output the summary. For example, the LLM may process the prompt based on the transcript portion and the selected intent to generate the summary such that the summary captures the essence of the transcript portion related to the selected intent.

The method 400 also includes causing the first summary (e.g., summary 212-1) of the communication session to be displayed (block 410). The communication session summarization component 116 may send the summary 212-1 to the customer relationship management component 128 for display. For example, the customer relationship management dashboard 300 may display the summary 212-1 using the editable summary text box 308. In some embodiments a user may review the summary for accuracy, make any necessary edits, and use the information for further action or documentation purposes.

The method 400 may repeat a respective iteration of blocks 404 through 410 for each of one or more additional intent(s), in some embodiments.

In some embodiments, the method 400 may include a user (e.g., an advocate) selection of a portion of participant metadata 120 to be included in CRM metadata 210-1. The portion of participant metadata 120 may be selected from all the metadata associated with a participant, all participant metadata related to a presently selected intent, all participant metadata related to a previously selected intent, etc. The user selection of participant metadata from the larger set of participant metadata may allow for the inclusion of additional context or information related to the participant, which advantageously ensures that summaries are accurate. In other embodiments, the participant metadata may be pre-populated by an LLM (e.g., LLM 118 or a different LLM) prompted with the larger set of participant metadata and the selected intent extracting the relevant participant metadata from the larger set of participant metadata.

In some embodiments, the method 400 may include a user revision of the summary 212-1, 212-2, etc. using editable summary text box 308. The user revision of the summary 212-1, 212-2, etc. may be stored as one or more suitable data objects such as a plain text file (e.g., .txt), structured text format (e.g., .JSON, .XML, .YAML, etc.), database tables (e.g., MySQL, PostgreSQL), and/or specialized transcript formats (e.g., .trs, .vtt). The user revision allows advocates to refine the summary 212-1, 212-2, etc. by making edits, deletions, additions, etc. ensuring that the final documentation accurately reflects the communication session's content and outcomes.

In some embodiments, the method 400 may include generating an overall summary of the communication session. The overall summary of the communication session may provide a comprehensive review that encapsulates the entire conversation, including all identified intents, advocate comments, CRM-metadata, and any additional data and/or information used in the summarization process. The overall summary may serve as a complete record of the communication session.

It is to be understood that the transcript portion 206-1, 206-2, etc. is not limited by the first and/or previously selected intent(s) but may include a plurality of transcript spans (e.g., a transcript portion 206-3 between the first and third selected intent, a transcript portion 206-5 between the beginning and the fifth selected intent, a transcript portion 206-12 between the eighth selected intent and the end of the communication session, etc.). The actions of the method 400 may be performed any suitable number of times (e.g., to summarize multi-intent conversations), in any suitable order, and/or may include fewer, additional, or different actions.

### EXAMPLES

Example 1. A computer-implemented method comprising: receiving, by one or more processors, a textual transcript based on a communication session established with a communication device; receiving, by the one or more processors and during the communication session, a user selection of a first intent; generating, by the one or more processors, a first prompt based at least in part on (i) the selected first intent and (ii) at least a portion of the textual transcript; generating, by the one or more processors, a first summary of the communication session corresponding to the first intent, wherein generating the first summary of the communication session includes inputting the first prompt into a large language model (LLM); and causing, by the one or more processors, the first summary of the communication session to be displayed.
Example 2. The computer-implemented method of example 1, wherein generating the first prompt is based at least in part on (i) the selected first intent, (ii) at least the portion of the textual transcript, and (iii) participant metadata.
Example 3. The computer-implemented method of example 2, wherein generating the first prompt includes extracting the participant metadata from a larger set of participant metadata by prompting the LLM, or a different LLM, with at least the larger set of participant metadata and the first intent.
Example 4. The computer-implemented method of example 1, wherein the user selection of the first intent is a user selection from a set of pre-determined intents that are selectable via a user interface, and wherein causing the first summary of the communication session to be displayed occurs during the communication session and via the user interface.
Example 5. The computer-implemented method of example 4, further comprising: receiving, by the one or more processors, a user revision of the first summary of the communication session via the user interface; and storing, by the one or more processors, one or more data objects representing the user revision of the first summary of the communication session.
Example 6. The computer-implemented method of example 1, further comprising: generating, by the one or more processors and after the communication session, an overall summary of the communication session, wherein generating the overall summary of the communication session includes inputting a second prompt into the LLM, and wherein the second prompt includes an entirety of the textual transcript.
Example 7. The computer-implemented method of example 1, wherein generating the first prompt is based on the portion of the textual transcript and no other portion of the textual transcript, and wherein the portion of the textual transcript consists of the textual transcript between a first time corresponding to a beginning of the communication session and a second time corresponding to the user selection of the first intent.
Example 8. The computer-implemented method of example 1, wherein generating the first prompt is based on the portion of the textual transcript and no other portion of the textual transcript, and wherein the portion of the textual transcript consists of the textual transcript between a first time corresponding to a user selection of a previous intent and a second time corresponding to the user selection of the first intent.
Example 9. A system comprising: one or more processors; and one or more memories storing processor-executable instructions that, when executed by the one or more processors, cause the one or more processors to perform operations comprising: receiving a textual transcript based on a communication session established with an electronic device; receiving, during the communication session, a user selection of a first intent; generating a first prompt based at least in part on (i) the selected first intent and (ii) at least a portion of the textual transcript; generating a first summary of the communication session corresponding to the first intent, wherein generating the first summary of the communication session includes inputting the first prompt into a large language model (LLM); and causing the first summary of the communication session to be displayed.
Example 10. The system of example 9, wherein the processor-executable instructions, when executed by the one or more processors, cause the one or more processors to generate the first prompt based at least in part on (i) the selected first intent, (ii) at least the portion of the textual transcript, and (iii) participant metadata.
Example 11. The system of example 10, wherein the processor-executable instructions, when executed by the one or more processors, further cause the one or more processors to extract the participant metadata from a larger set of participant metadata by prompting the LLM, or a different LLM, with at least the larger set of participant metadata and the first intent.
Example 12. The system of example 9, wherein the user selection of a first intent is a user selection from a set of pre-determined intents that are selectable via a user interface, and wherein causing the first summary of the communication session to be displayed occurs during the communication session and via the user interface.
Example 13. The system of example 12, further comprising processor-executable instructions that when executed by the one or more processors, cause the one or more processors to perform operations comprising: receive a user revision of the first summary of the communication session via the user interface; and store one or more data objects representing the user revision of the first summary of the communication session.
Example 14. The system of example 9, further comprising processor-executable instructions that when executed by the one or more processors, cause the one or more processors to perform operations comprising: generate, after the communication session, an overall summary of the communication session, wherein to generate the overall summary of the communication session a second prompt is inputted into the LLM, and wherein the second prompt includes an entirety of the textual transcript.
Example 15. The system of example 9, wherein to generate the first prompt, the first prompt is based on the portion of the textual transcript and no other portion of the textual transcript, and wherein the portion of the textual transcript consists of the textual transcript between a first time corresponding to a beginning of the communication session and a second time corresponding to the user selection of the first intent.
Example 16. The system of example 9, wherein to generate the first prompt, the first prompt is based on the portion of the textual transcript and no other portion of the textual transcript, and wherein the portion of the textual transcript consists of the textual transcript between a first time corresponding to a user selection of a previous intent and a second time corresponding to the user selection of the first intent.
Example 17. One or more non-transitory computer-readable media storing processor-executable instructions that, when executed by one or more processors, cause the one or more processors to perform operations comprising: receiving a textual transcript based on a communication session established with an electronic device; receiving, during the communication session, a user selection of a first intent; generating a first prompt based at least in part on (i) the selected first intent and (ii) at least a portion of the textual transcript; generating a first summary of the communication session corresponding to the first intent, wherein to generate the first summary of the communication session the first prompt is inputted into a large language model (LLM); and causing the first summary of the communication session to be displayed.
Example 18. The one or more non-transitory computer-readable storage media of example 17, wherein the processor-executable instructions, when executed by the one or more processors, cause the one or more processors to generate the first prompt based at least in part on (i) the selected first intent, (ii) at least the portion of the textual transcript, and (iii) participant metadata.
Example 19. The one or more non-transitory computer-readable storage media of example 18, wherein the processor-executable instructions, when executed by the one or more processors, further cause the one or more processors to extract the participant metadata from a larger set of participant metadata by prompting the LLM, or a different LLM, with at least the larger set of participant metadata and the first intent.
Example 20. The one or more non-transitory computer-readable storage media of example 17, wherein the user selection of a first intent is a user selection from a set of pre-determined intents that are selectable via a user interface, and wherein causing the first summary of the communication session to be displayed occurs during the communication session and via the user interface.

### Additional Considerations

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method comprising:
receiving, by one or more processors, a textual transcript based on a communication session established with an electronic device;
receiving, by the one or more processors and during the communication session, a user selection of a first intent;
generating, by the one or more processors, a first prompt based at least in part on (i) the selected first intent and (ii) at least a portion of the textual transcript;
generating, by the one or more processors, a first summary of the communication session corresponding to the first intent, wherein generating the first summary of the communication session includes inputting the first prompt into a large language model (LLM); and
causing, by the one or more processors, the first summary of the communication session to be displayed.

2. The computer-implemented method of claim 1, wherein generating the first prompt is based at least in part on (i) the selected first intent, (ii) at least the portion of the textual transcript, and (iii) participant metadata.

3. The computer-implemented method of claim 2, wherein generating the first prompt includes extracting the participant metadata from a larger set of participant metadata by prompting the LLM, or a different LLM, with at least the larger set of participant metadata and the first intent.

4. The computer-implemented method of claim 1, wherein the user selection of the first intent is a user selection from a set of pre-determined intents that are selectable via a user interface, and wherein causing the first summary of the communication session to be displayed occurs during the communication session and via the user interface.

5. The computer-implemented method of claim 4, further comprising:
receiving, by the one or more processors, a user revision of the first summary of the communication session via the user interface; and
storing, by the one or more processors, one or more data objects representing the user revision of the first summary of the communication session.

6. The computer-implemented method of claim 1, further comprising:
generating, by the one or more processors and after the communication session, an overall summary of the communication session, wherein generating the overall summary of the communication session includes inputting a second prompt into the LLM, and wherein the second prompt includes an entirety of the textual transcript.

7. The computer-implemented method of claim 1, wherein generating the first prompt is based on the portion of the textual transcript and no other portion of the textual transcript, and wherein the portion of the textual transcript consists of the textual transcript between a first time corresponding to a beginning of the communication session and a second time corresponding to the user selection of the first intent.

8. The computer-implemented method of claim 1, wherein generating the first prompt is based on the portion of the textual transcript and no other portion of the textual transcript, and wherein the portion of the textual transcript consists of the textual transcript between a first time corresponding to a user selection of a previous intent and a second time corresponding to the user selection of the first intent.

9. A system comprising:
one or more processors; and
one or more memories storing processor-executable instructions that, when executed by the one or more processors, cause the one or more processors to perform operations comprising:
receiving a textual transcript based on a communication session established with an electronic device;
receiving, during the communication session, a user selection of a first intent;
generating a first prompt based at least in part on (i) the selected first intent and (ii) at least a portion of the textual transcript;
generating a first summary of the communication session corresponding to the first intent, wherein generating the first summary of the communication session includes inputting the first prompt into a large language model (LLM); and
causing the first summary of the communication session to be displayed.

10. The system of claim 9, wherein the processor-executable instructions, when executed by the one or more processors, cause the one or more processors to generate the first prompt based at least in part on (i) the selected first intent, (ii) at least the portion of the textual transcript, and (iii) participant metadata.

11. The system of claim 10, wherein the processor-executable instructions, when executed by the one or more processors, further cause the one or more processors to extract the participant metadata from a larger set of participant metadata by prompting the LLM, or a different LLM, with at least the larger set of participant metadata and the first intent.

12. The system of claim 9, wherein the user selection of a first intent is a user selection from a set of pre-determined intents that are selectable via a user interface, and wherein causing the first summary of the communication session to be displayed occurs during the communication session and via the user interface.

13. The system of claim 12, further comprising processor-executable instructions that when executed by the one or more processors, cause the one or more processors to perform operations comprising:
receive a user revision of the first summary of the communication session via the user interface; and
store one or more data objects representing the user revision of the first summary of the communication session.

14. The system of claim 9, further comprising processor-executable instructions that when executed by the one or more processors, cause the one or more processors to perform operations comprising:
generate, after the communication session, an overall summary of the communication session, wherein to generate the overall summary of the communication session a second prompt is inputted into the LLM, and wherein the second prompt includes an entirety of the textual transcript.

15. The system of claim 9, wherein to generate the first prompt, the first prompt is based on the portion of the textual transcript and no other portion of the textual transcript, and wherein the portion of the textual transcript consists of the textual transcript between a first time corresponding to a beginning of the communication session and a second time corresponding to the user selection of the first intent.

16. The system of claim 9, wherein to generate the first prompt, the first prompt is based on the portion of the textual transcript and no other portion of the textual transcript, and wherein the portion of the textual transcript consists of the textual transcript between a first time corresponding to a user selection of a previous intent and a second time corresponding to the user selection of the first intent.

17. One or more non-transitory computer-readable media storing processor-executable instructions that, when executed by one or more processors, cause the one or more processors to perform operations comprising:
receiving a textual transcript based on a communication session established with an electronic device;
receiving, during the communication session, a user selection of a first intent;
generating a first prompt based at least in part on (i) the selected first intent and (ii) at least a portion of the textual transcript;
generating a first summary of the communication session corresponding to the first intent, wherein to generate the first summary of the communication session the first prompt is inputted into a large language model (LLM); and
causing the first summary of the communication session to be displayed.

18. The one or more non-transitory computer-readable media of claim 17, wherein the processor-executable instructions, when executed by the one or more processors, cause the one or more processors to generate the first prompt based at least in part on (i) the selected first intent, (ii) at least the portion of the textual transcript, and (iii) participant metadata.

19. The one or more non-transitory computer-readable media of claim 18, wherein the processor-executable instructions, when executed by the one or more processors, further cause the one or more processors to extract the participant metadata from a larger set of participant metadata by prompting the LLM, or a different LLM, with at least the larger set of participant metadata and the first intent.

20. The one or more non-transitory computer-readable media of claim 17, wherein the user selection of a first intent is a user selection from a set of pre-determined intents that are selectable via a user interface, and wherein causing the first summary of the communication session to be displayed occurs during the communication session and via the user interface.
